(19) United States
(12) Patent Application Publication
(10) Pub. No.: US 2010/0232541 A1
(43) Pub. Date: Sep. 16, 2010

(54) DATA TRANSMISSION SYSTEM, RECEIVING APPARATUS AND DATA TRANSMISSION METHOD USING THE SAME

(75) Inventors: Muneo Fukaishi, Minato-ku (JP); Kouichi Yamaguchi, Minato-ku (JP); Kazuhisa Sunaga, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku ,Tokyo (JP)

(21) Appl. No.: 12/160,997

(22) PCT Filed: Nov. 1, 2006
(86) PCT No.: PCT/JP2006/321820

§ 371 Date: Jul. 29, 2008

(30) Foreign Application Priority Data
Jan. 16, 2006 (JP) 2006-007519

(51) Int. Cl. H04L 25/49

(52) U.S. Cl. 375/291

(57) ABSTRACT

Precoded data transmitted from transmitting apparatus (101) is received by receiving apparatus (102) as duobinary data being ternary data via transmission path (103), and the duobinary data is converted into differential data being binary data by absolute value converter (121) comprising an AND gate and an OR gate.

### TECHNICAL FIELD

The present invention relates to a data transmission system comprising a semiconductor integrated circuit, a receiving apparatus and a data transmission method using the same, and particularly to a data transmission system in which an electric signal is transmitted via electric wiring in a connecting cable or on a printed circuit board, a receiving apparatus and a data transmission method using the same.

### BACKGROUND ART

In recent years, along with the micronization of a semiconductor, the operation speed of a chip has been increased and chip performance has been improved for higher integration. Along with such improvement of chip performance, the amount of data exchanged among chips has been also increased. Accordingly, the increase of the data amount has been addressed by increasing the number of signals transmitted in parallel, or improving the transmission speed of a transmitted signal.

An action on the increase of the data amount due to the increase of the number of signals may induce the increase of pad areas to retrieve a signal from an LSI, or the increase of media such as electric wiring or connecting cables on a printed circuit board. Accordingly, as an action on the increase of the data amount, speeding up of the signal transmission could be more efficient.

However, the improvement of the transmission speed may induce the increase of signal attenuation in a transmission medium, or intersignal interference in which an attenuated signal waveform affects adjacent bits.

Accordingly, duobinary transmission is known for the purpose of inhibiting the decrease of the signal amplitude due to the signal attenuation, or the degradation of signal timing due to the increase of the intersignal interference. The duobinary transmission is a transmission scheme to allow interference of neighboring (previous and next) bits so as to cut down the amount of signal attenuation and also inhibit the timing degradation due to the intersignal interference. That is, the transmission technique is to allow only the distortion of a waveform between neighboring signals, instead of completely eliminating distortion (intersignal interference) of a waveform due to attenuation in a transmission path, so as to compress a frequency band required for transmission into two thirds. This can accomplish speeding up of about 1.5 times as conventional binary transmission that does not allow intersignal interference.

The duobinary transmission allows interference with previous data, so that received data is ternary data while transmitted data is binary data. Specifically, if previous data and current data are both “0”, received data is “0”. Otherwise, if previous data is “0” and current data is “1”, or previous data is “1” and current data is “0”, then received data is “1”. Otherwise, if previous data and current data are both “1”, received data is “2”.

FIG. 1 is a diagram showing a waveform of typical received data subjected to duobinary transmission.

In the duobinary transmission, it is possible to inhibit timing degradation due to signal attenuation and intersignal interference being an impediment to speeding up, but ternary data described in the above needs to be received. In the receiving of ternary data, two thresholds of reference voltage Vref+ and reference voltage Vref− are used to determine whether received data is “0”, “1” or “2” by differentiating a first eye aperture formed between received data “0” and “1” and a second eye aperture formed between received data “1” and “2”, as shown in FIG. 1. Herein, a value smaller than reference voltage Vref− is “0”, a value larger than reference voltage Vref− and smaller than reference voltage Vref+ is “1”, and a value larger than reference voltage Vref+ is “2”.

As described in the above, in the duobinary transmission, received data changes depending on immediately preceding transmitted data. As such, once there is an error in transmitted data, the error may propagate to the following received data.

To avoid such error propagation, coding processing is widely used in which a transmitting side previously uses a precoder.

FIG. 2 is a diagram showing one exemplary embodiment of a conventional transmission/reception system for duobinary transmission using coding processing by a precoder.

The transmission/reception system shown in FIG. 2 consists of transmitting apparatus 501 for transmitting precoded data, transmission path 503 for converting the precoded data transmitted from transmitting apparatus 501 into duobinary data and transmitting the result, and receiving apparatus 502 for receiving the data converted into the duobinary data and transmitted by transmission path 503. Transmitting apparatus 501 is provided with precoder 511. Precoder 511 converts input data being inputted into precoded data and transmits the result to transmission path 503. Receiving apparatus 502 is provided with decoder 521 and determiner 522. Determiner 522 generates decision data from received duobinary data. Decoder 521 decodes the decision data generated by determiner 522 to generate decoded data.

FIG. 3 is a diagram showing detailed configuration of determiner 522 and decoder 521 shown in FIG. 2.

As shown in FIG. 3, determiner 522 shown in FIG. 2 is provided with two differential determiners 523 and 524. Each of differential determiners 523 and 524 is provided with two input terminals. Duobinary data is inputted to one input terminal, while reference voltage Vref+ being an arbitrary threshold voltage is inputted in the case of differential determiner 523 and reference voltage Vref− being an arbitrary threshold voltage is inputted in the case of differential determiner 524, to the other input terminal. Herein, reference voltage Vref+ is higher voltage than reference voltage Vref−. Differential determiners 523 and 524 determine whether inputted duobinary data is of higher voltage or lower voltage than the reference voltage, and output the result as decision data. Decoder 521, which consists of an exclusive OR circuit, outputs decoded data based on the decision data.

FIG. 4 is a diagram showing how data transits during duobinary transmission in the transmission/reception system shown in FIG. 2.

Numerical values shown in respective fields in FIG. 4 represent transmitted/received data columns in order of time from the left to the right. For example, if input data is two bits “00” and the last data of precoded data in brackets is “0”, and if the precoded data is “00” and the last data of the precoded data in brackets is “1”, then the precoded data is “11”. In this case, duobinary data obtained as results of passing through transmission path 503 are “00” and “22”, respectively. Afterward, as a result of determination of the precoded data by determiner 522 of receiving apparatus 502, if duobinary data is “00”, decision data outputted from differential determiner 523 is “00” and decision data outputted from differential determiner 524 is “00”. Otherwise, if duobinary data is “22”, then decision data outputted from differential determiner 523 is “11” and decision data outputted from differential determiner 524 is “11”. Whether decision data is “00” or “11”, decoded data obtained by decoder 521 are both “00”, thus it can be seen that the input data has been correctly transmitted and received.

If input data is two bits “01” and the last data of precoded data in brackets is “0”, precoded data is “01”. Otherwise, if the last data of precoded data in brackets is “1”, precoded data is “10”. In this case, duobinary data obtained as results of passing through transmission path 503 are “01” and “21”, respectively. Afterward, as a result of determination of the data by determiner 522 of receiving apparatus 502, if duobinary data is “01”, decision data outputted from differential determiner 523 is “00” and decision data outputted from differential determiner 524 is “01”. Otherwise, if duobinary data is “21”, decision data outputted from differential determiner 523 is “10” and decision data outputted from differential determiner 524 is “11”. Whether decision data is “00” or “01”, and whether decision data is “10” or “11”, decoded data obtained by decoder 521 are both “01”, thus it can be seen that the input data has been correctly transmitted and received.

If input data is two bits “10” and the last data of precoded data in brackets is “0”, precoded data is “11”. Otherwise, if the last data of precoded data in brackets is “1”, precoded data is “00”. In this case, duobinary data obtained as results of passing through transmission path 503 are “12” and “10”, respectively. Afterward, as a result of determination of the data by determiner 522 of receiving apparatus 502, if duobinary data is “12”, decision data outputted from differential determiner 523 is “01” and decision data outputted from differential determiner 524 is “11”. Otherwise, if duobinary data is “10”, decision data outputted from differential determiner 523 is “00” and decision data outputted from differential determiner 524 is “10”. Whether decision data is “01” or “11” and whether decision data is “00” or “10”, decoded data obtained by decoder 521 are both “10”, thus it can be seen that the input data has been correctly transmitted and received.

If input data is two bits “11” and the last data of precoded data in brackets is “0”, precoded data is “10”; if the last data of precoded data in brackets is “1”, precoded data is “01”. In this case, duobinary data obtained as results of passing through transmission path 503 are both “11”. Afterward, as a result of determination of the data by determiner 522 of receiving apparatus 502, decision data outputted from differential determiner 523 is “00” and decision data outputted from differential determiner 524 is “11”. And decoded data obtained by decoder 521 are both “11”, thus it can be seen that the input data has been correctly transmitted and received.

FIG. 5 is a diagram showing a configuration example of differential determiners 523 and 524 shown in FIG. 3.

Differential determiners 523 and 524 shown in FIG. 5 are configured as sampling-latch type differential determinators, and are circuits to which two reference voltages are inputted in addition to differential data to determine a differential.

A method has been proposed for converting a ternary code into an absolute value to speed up processing of transmitted/received data similarly to the duobinary transmission, although not same as the duobinary transmission (for example, see Japanese Patent Laid-Open No. 1994-076494).

However, the above described method using the reference voltage has a problem in that the reference voltage must be set correctly. The method also has a problem in that since the size of the eye aperture changes depending on the attenuation property of the transmission path, the reference voltage must be set depending on the attenuation property.

According to the method disclosed in the above patent document, ternary data is converted into an absolute value and converted into a digital signal by an A/D converter, and then data values other than desired sample data are subjected to waveform equalization to be smaller for identification of the data. The data is read from a magnetic recording medium referred to in the above patent document at about tens of megabits to hundreds of megabits per second, in which relatively lower data is converted into an absolute value, i.e., binary data. However, the method has a problem in that data converted into an absolute value may have been distorted to convert ternary data into an absolute value, i.e., binary data, actually in high-speed electrical transmission over gigabits per second as in transmission between LSI chips. Moreover, according to the above patent document, the A/D converter is used after the conversion into an absolute value, where the A/D converter needs to operate at the speed over gigahertz per second for similar performance to transmission among LSI chips. Therefore, the method has a problem in that it is difficult to apply the current A/D converter operating at the speed of hundreds of megahertz.

To solve the above problems, it is an object of the present invention to provide a data transmission system that can identify received data more easily, a receiving apparatus and a data transmission method using the same.

### DISCLOSURE OF THE INVENTION

To achieve the above object, the present invention is characterized by a data transmission system including a transmitting apparatus for transmitting data, and a receiving apparatus for receiving, via a transmission path, the data transmitted from the transmitting apparatus as duobinary data being ternary data, wherein:

the receiving apparatus includes absolute value converting means for converting the duobinary data into binary data.

Further, the present invention is characterized in that the transmitting apparatus includes a precoder for converting inputted data into precoded data.

Further, the present invention is characterized in that the receiving apparatus includes offset cancel means for cancelling a common voltage offset of the binary data.

Further, the present invention is characterized in that the offset cancel means is connected to a rear stage of the absolute value converting means.

Further, the present invention is characterized in that the offset cancel means controls an output voltage of the absolute value converting means.

Further, the present invention is characterized in that the absolute converting means is a differential circuit comprising an AND gate and an OR gate.

Further, the present invention is characterized in that:

the receiving apparatus includes distortion eliminating means for eliminating distortion of the binary data; and

the distortion eliminating means is connected to a rear stage of the absolute value converting means.

Further, the present invention is characterized in that the distortion eliminating means is a low-pass filter.

Further, the present invention is characterized in that:

the receiving apparatus includes differential amplifying means for amplifying the binary data; and

the differential amplifying means is connected to a rear stage of the absolute value converting means.

Further, the present invention is characterized by a receiving apparatus for receiving, via a transmission path, data transmitted from a transmitting apparatus for transmitting data as duobinary data being ternary data, the receiving apparatus being connected to the transmitting apparatus via the transmission path, wherein:

the receiving apparatus includes absolute value converting means for converting the duobinary data into binary data.

Further, the present invention is characterized in that the receiving apparatus includes offset cancel means for cancelling a common voltage offset of the binary data.

Further, the present invention is characterized in that the offset cancel means is connected to a rear stage of the absolute value converting means.

Further, the present invention is characterized in that the offset cancel means controls an output voltage of the absolute value converting means.

Further, the present invention is characterized in that the absolute converting means is a differential circuit comprising an AND gate and an OR gate.

Further, the present invention is characterized in that:

the receiving apparatus includes distortion eliminating means for eliminating distortion of the binary data; and

the distortion eliminating means is connected to a rear stage of the absolute value converting means.

Further, the present invention is characterized in that the distortion eliminating means is a low-pass filter.

Further, the present invention is characterized in that:

the receiving apparatus includes differential amplifying means for amplifying the binary data; and

the differential amplifying means is connected to a rear stage of the absolute value converting means.

Further, the present invention is characterized by a data transmission method in a data transmission system including a transmitting apparatus for transmitting data, and a receiving apparatus for receiving, via a transmission path, the data transmitted from the transmitting apparatus as duobinary data being ternary data, wherein:

the receiving apparatus performs processing to convert the duobinary data into binary data.

Further, the present invention is characterized in that the transmitting apparatus performs processing to convert inputted data into precoded data.

Further, the present invention is characterized in that the receiving apparatus performs processing to cancel a common voltage offset of the binary data.

Further, the present invention is characterized in that the receiving apparatus performs processing to eliminate distortion of the binary data.

Further, the present invention is characterized in that the receiving apparatus performs processing to amplify the binary data.

According to the present invention with the above configuration, data transmitted from the transmitting apparatus is received by the receiving apparatus as duobinary data being ternary data via the transmission path, and the duobinary data is converted into binary data by the absolute value converting means.

In this manner, duobinary data is converted into binary data by being converted into an absolute value, so that it is not necessary to provide complex circuit configuration to analyze ternary data.

As described in the above, the present invention is configured such that the receiving apparatus receives data transmitted from the transmitting apparatus as duobinary data being ternary data via the transmission path, and the absolute value converting means provided in the receiving apparatus converts the duobinary data into the binary data, allowing for more easy identification of the received data.

### BRIEF DESCRIPTION OF THE DRAWINGS

FIG. 1 is a diagram showing a waveform of typical received data subjected to duobinary transmission;

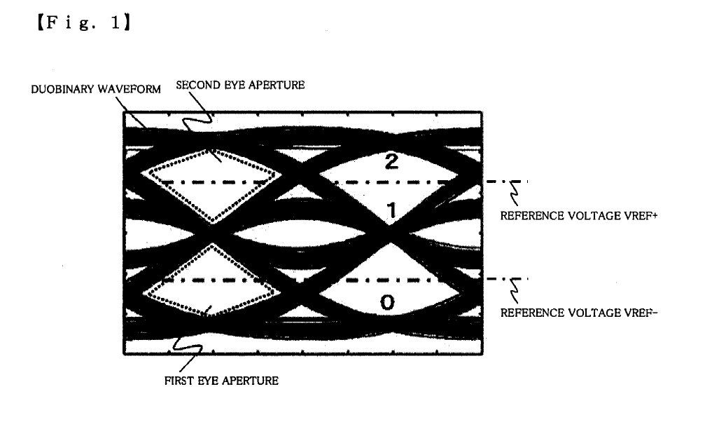

FIG. 2 is a diagram showing one exemplary embodiment of a conventional transmission/reception system for duobinary transmission using coding processing by a precoder;

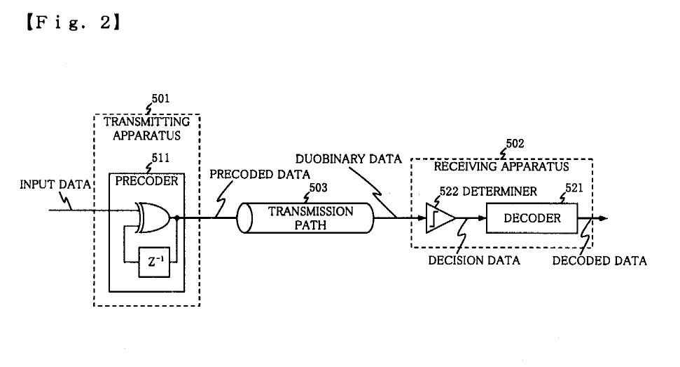

FIG. 3 is a diagram showing detailed configuration of a determiner and a decoder shown in FIG. 2;

FIG. 4 is a diagram showing how data transits during duobinary transmission in the transmission/reception system shown in FIG. 2;

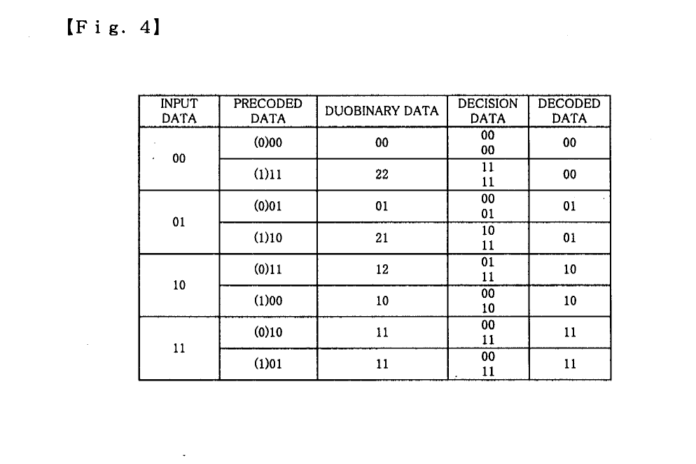

FIG. 5 is a diagram showing a configuration example of differential determiners shown in FIG. 3;

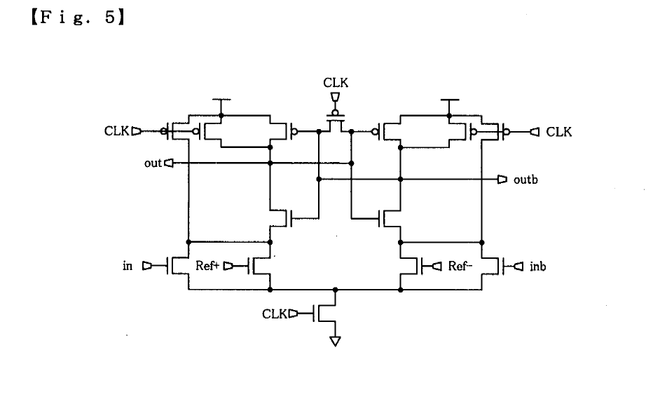

FIG. 6 is a diagram showing one exemplary embodiment of a data transmission system according to the present invention;

FIG. 7 is a diagram showing the configuration of a receiving apparatus shown in FIG. 6, and waveforms of duobinary data inputted to an absolute value converter and differential data outputted from the absolute value converter;

FIG. 8 is a diagram showing how data transits during duobinary transmission in the data transmission system shown in FIG. 6;

FIG. 9 is a diagram showing one example of a circuit in the absolute value converter shown in FIGS. 6 and 7;

FIG. 10 is a diagram showing input/output waveforms in the circuit in the absolute value converter shown in FIG. 9;

FIG. 11 is a diagram showing configuration including an offset canceler in the next stage of the absolute value converter of the receiving apparatus shown in FIG. 7;

FIG. 12 is a diagram showing respective examples of the circuits in the absolute value converter and the offset canceler of the receiving apparatus shown in FIG. 11;

FIG. 13 is a diagram showing input/output waveforms in the circuits in the absolute value converter and the offset canceler shown in FIG. 12;

FIG. 14 is a diagram showing configuration including a distortion eliminator in the next stage of the offset canceler of the receiving apparatus shown in FIG. 11;

FIG. 15 is a diagram showing respective examples of the circuits in the absolute value converter, the offset canceler and the distortion eliminator of the receiving apparatus shown in FIG. 14; and

FIG. 16 is a diagram showing input/output waveforms in the circuits in the absolute value converter, the offset canceler and the distortion eliminator shown in FIG. 15.

### BEST MODE FOR CARRYING OUT THE INVENTION

The following will describe exemplary embodiments of the present invention with reference to the drawings.

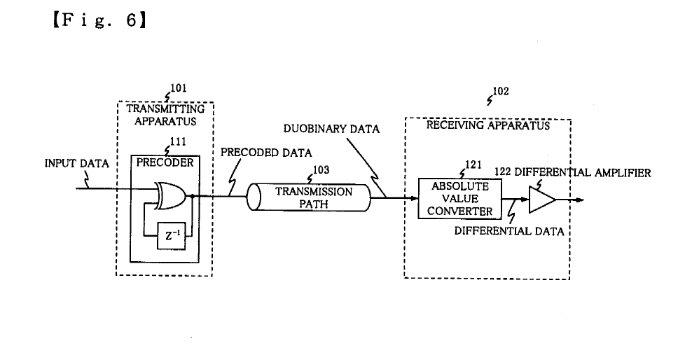

FIG. 6 is a diagram showing one exemplary embodiment of a data transmission system according to the present invention.

As shown in FIG. 6, this exemplary embodiment comprises transmitting apparatus 101 for transmitting precoded data, transmission path 103 to transmit the precoded data transmitted from transmitting apparatus 101 after conversion of the precoded data into duobinary data, and receiving apparatus 102 for receiving the data converted into duobinary data in and transmitted through transmission path 103. Transmitting apparatus 101 comprises precoder 111. Precoder 111 converts input data being inputted into precoded data and transmits the precoded data to transmission path 103. Receiving apparatus 102 comprises absolute value converter 121 and differential amplifier 122. Absolute value converter 121 converts received duobinary data being ternary into an absolute value and generates binary differential data. Differential amplifier 122 amplifies differential data outputted from absolute value converter 121.

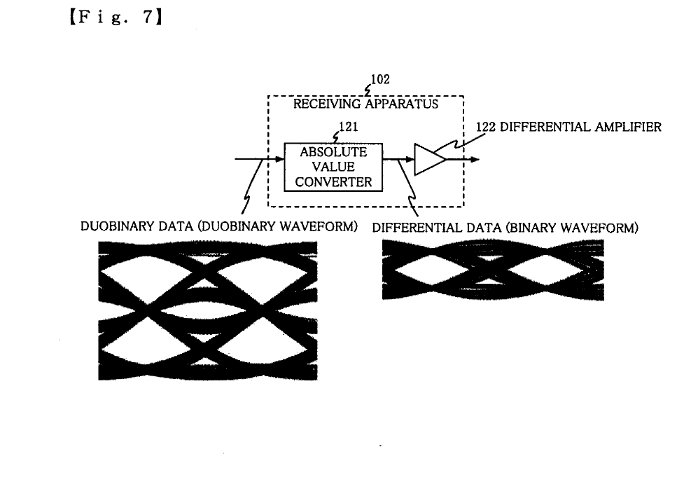

FIG. 7 is a diagram showing the configuration of receiving apparatus 102 shown in FIG. 6, and waveforms of duobinary data inputted to absolute value converter 121 and differential data outputted from absolute value converter 121.

As shown in FIG. 7, duobinary data inputted to absolute value converter 121 is converted into an absolute value in absolute value converter 121 to generate binary differential data and the data is outputted to differential amplifier 122. If output of absolute value converter 121 is binary differential data with sufficient amplitude and can be received in the next stage, differential amplifier 122 is not necessary that is connected to the next stage of absolute value converter 121.

Absolute value converter 121 shown in FIG. 7 reverses inputted duobinary data being ternary from the center to up or down of the amplitude. That is, if the duobinary data being ternary is represented as “−1”, “0” and “1” from low voltage data to high voltage data, then absolute value converter 121 converts “−1”, “0” and “1” in the input data into “1”, “0” and “1”, respectively.

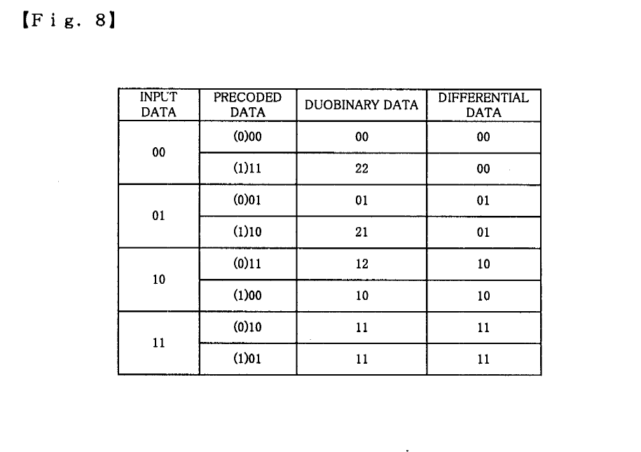

FIG. 8 is a diagram showing how data transits during duobinary transmission in the data transmission system shown in FIG. 6. The drawing shows input data being inputted to transmitting apparatus 101, a precoded data converted and transmitted in precoder 111 of transmitting apparatus 101, duobinary data transmitted through transmission path 103 and received by receiving apparatus 102, and differential data outputted from absolute value converter 121 of receiving apparatus 102 in association with one another.

Numerical values shown in respective fields in FIG. 8 represent transmitted/received data columns in order of time from the left to the right.

For example, if input data being inputted to precoder 111 is two bits “00” and the last data of precoded data in brackets shown in FIG. 8 is “0”, the input data is converted into precoded data “00” by precoder 111. Otherwise, if the last data of precoded data in brackets shown in FIG. 8 is “1”, the input data is converted into precoded data “11” by precoder 111. In this case, duobinary data obtained as results of that the respective precoded data pass through transmission path 103 are “00” and “22”, respectively. Afterward, the duobinary data is converted into differential data by absolute value converter 121 of receiving apparatus 102. If duobinary data is “00”, differential data is “00”. Also if duobinary data is “22”, differential data is “00”.

If input data being inputted to precoder 111 is two bits “01” and the last data of precoded data in brackets shown in FIG. 8 is “0”, the input data is converted into precoded data “01” by precoder 111. Otherwise, if the last data of precoded data in brackets shown in FIG. 8 is “1”, the input data is converted into precoded data “10” by precoder 111. In this case, duobinary data obtained as results of that the respective precoded data pass through transmission path 103 are “01” and “21”, respectively. Afterward, the duobinary data is converted into differential data by absolute value converter 121 of receiving apparatus 102. If duobinary data is “01”, differential data is “01”. Also if duobinary data is “21”, differential data is “01”.

If input data being inputted to precoder 111 is two bits “10” and the last data of precoded data in brackets shown in FIG. 8 is “0”, the input data is converted into precoded data “11” by precoder 111. Otherwise, if the last data of precoded data in brackets shown in FIG. 8 is “1”, the input data is converted into precoded data “00” by precoder 111. In this case, duobinary data obtained as results of that the respective precoded data pass through transmission path 103 are “12” and “10”, respectively. Afterward, the duobinary data is converted into differential data by absolute value converter 121 of receiving apparatus 102. If duobinary data is “12”, differential data is “10”. Also if duobinary data is “10”, differential data is “10”.

If input data being inputted to precoder 111 is two bits “11” and the last data of precoded data in brackets shown in FIG. 8 is “0”, the input data is converted into precoded data “10” by precoder 111. Otherwise, if the last data of precoded data in brackets shown in FIG. 8 is “1”, the input data is converted into precoded data “01” by precoder 111. In this case, duobinary data obtained as results of that the respective precoded data pass through transmission path 103 are both “11”. Afterward, the duobinary data are converted into differential data by absolute value converter 121 of receiving apparatus 102, and the differential data are both “11”.

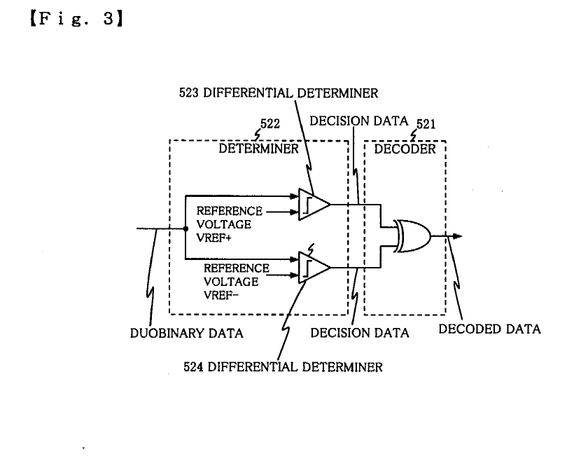

As can be seen from the above, input data being inputted to transmitting apparatus 101 has been correctly transmitted and received. It can be also seen that absolute value converter 121 serves functions of differential determiners 523 and 524 and decoder 521 of conventional receiving apparatus 502 shown in FIG. 3.

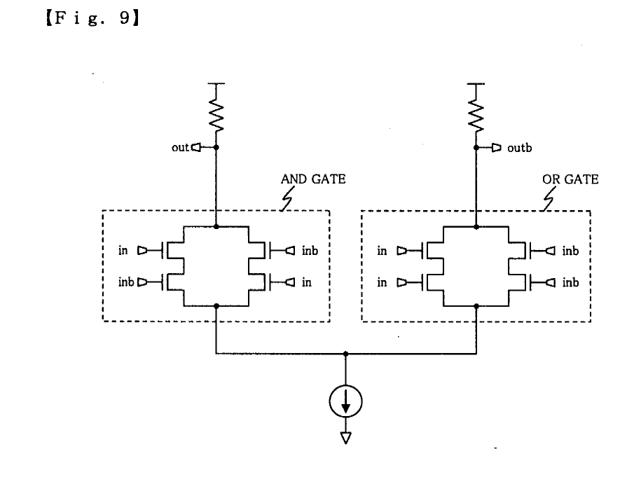

FIG. 9 is a diagram showing one example of a circuit in absolute value converter 121 shown in FIGS. 6 and 7.

As shown in FIG. 9, absolute value converter 121 has differential buffer configuration, in which a data input unit comprises an AND gate and an OR gate. It is also configured to be inputted “in” being differential input data and a signal “inb” being a counterpart to the “in” as input data.

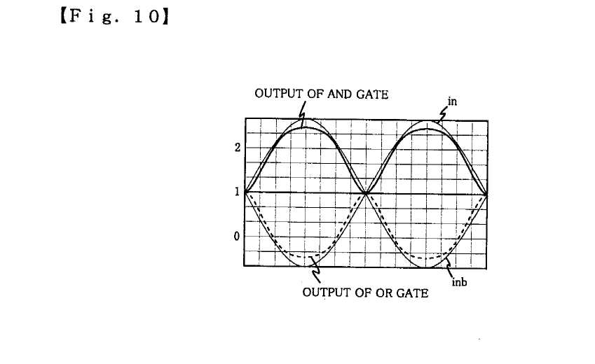

FIG. 10 is a diagram showing input/output waveforms in the circuit in absolute value converter 121 shown in FIG. 9.

As shown in FIG. 10, if “in” or “inb” is “0” or “2”, the AND gate outputs high voltage data; if “in” or “inb” is “1”, the AND gate outputs low voltage data.

Otherwise, if “in” or “inb” is “1”, the OR gate outputs high voltage data; if “in” or “inb” is “0” or “2”, the OR gate outputs low voltage data. As a result, it can be seen that output of absolute value converter 121 is a value converted from ternary input data into binary data.

However, as can be seen from the input/output waveforms shown in FIG. 10, output of the AND gate and output of the OR gate have voltage offsets. Even if the output is inputted to differential amplifier 122 as it is, differential amplifier 122 cannot amplify the output. As such, means for cancelling a voltage offset is provided in the next stage of absolute value converter 121 to convert data outputted from absolute value converter 121 into data that can be amplified by differential amplifier 122.

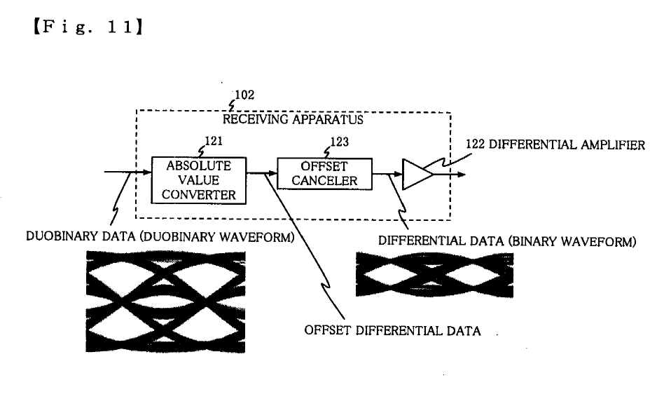

FIG. 11 is a diagram showing configuration including offset canceler 123 in the next stage of absolute value converter 121 of receiving apparatus 102 shown in FIG. 7.

Receiving apparatus 102 shown in FIG. 11 comprises offset canceler 123 between absolute value converter 121 and differential amplifier 122. Offset canceler 123 cancels a power offset of output of the AND gate and outputs the result.

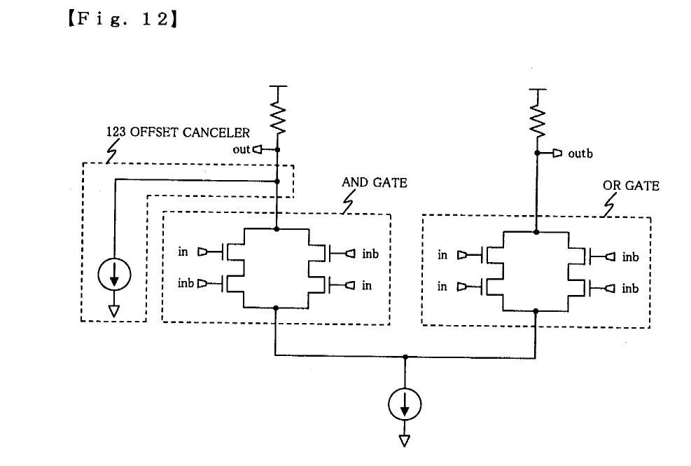

FIG. 12 is a diagram showing respective examples of the circuits in absolute value converter 121 and offset canceler 123 of receiving apparatus 102 shown in FIG. 11.

As shown in FIG. 12, receiving apparatus 102 shown in FIG. 11 comprises a current source at the output of the AND gate of a circuit in absolute value converter 121 shown in FIG. 9 so as to cancel a power offset of output of the AND gate. This forces an output value of the AND gate to decrease to a voltage value at a level equal to an output value of the OR gate.

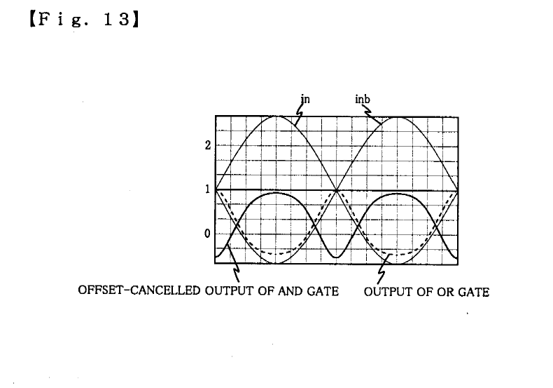

FIG. 13 is a diagram showing input/output waveforms in the circuits in absolute value converter 121 and offset canceler 123 shown in FIG. 12.

As shown in FIG. 13, it can be seen that output of the AND gate is a voltage value at a level equal to output of the OR gate, differently from the output waveform shown in FIG. 10 without offset canceler 123.

However, as can be seen from the input/output waveforms shown in FIG. 13, output of the AND gate and output of the OR gate are distorted such that the output waveform becomes narrow when data is “1” where input data “in” and “inb” are at the same potential. This is because shapes of input data are different when the data is “1” and when the data is “0” or “2”. If such a distorted waveform is inputted to differential amplifier 122, the duty ratio of data is not 50%, causing malfunctioning. Additionally, when the transmitting/receiving speed is high, the data distortion disables high-speed operation. Therefore, the distortion needs to be eliminated.

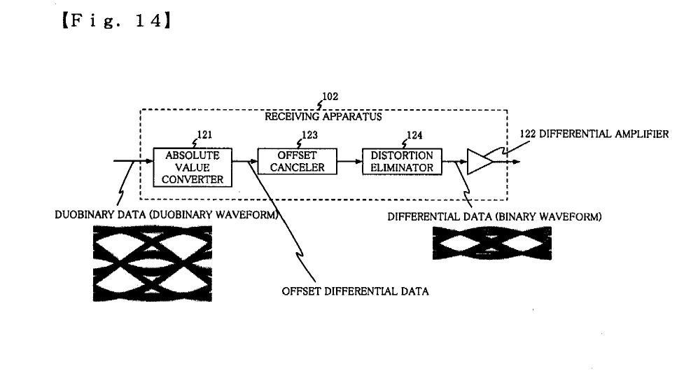

FIG. 14 is a diagram showing configuration including distortion eliminator 124 in the next stage of offset canceler 123 of receiving apparatus 102 shown in FIG. 11.

Receiving apparatus 102 shown in FIG. 14 comprises distortion eliminator 124 between offset canceler 123 and differential amplifier 122. Distortion eliminator 124 shapes distorted output data of offset canceler 123 and outputs the data of which waveform has been shaped to differential amplifier 122.

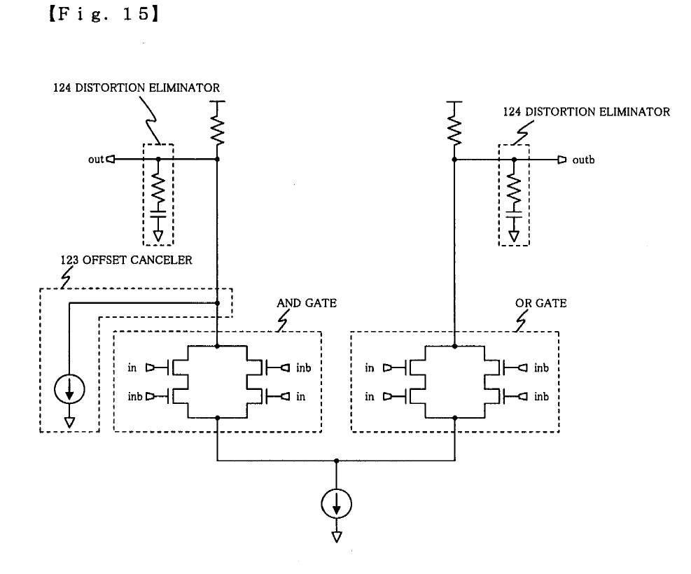

FIG. 15 is a diagram showing respective examples of the circuits in absolute value converter 121, offset canceler 123 and distortion eliminator 124 of receiving apparatus 102 shown in FIG. 14.

As shown in FIG. 15, receiving apparatus 102 shown in FIG. 14 comprises a current source at output of the AND gate of absolute value converter 121 so as to cancel a power offset of output of the AND gate, so that an output value of the AND gate is forced to decrease to a voltage value equal to the OR gate. Afterward, a low-pass filter being distortion eliminator 124 serving distortion eliminating function is connected to output of both the AND gate and the OR gate, and the distortion of output data is eliminated to shape a waveform.

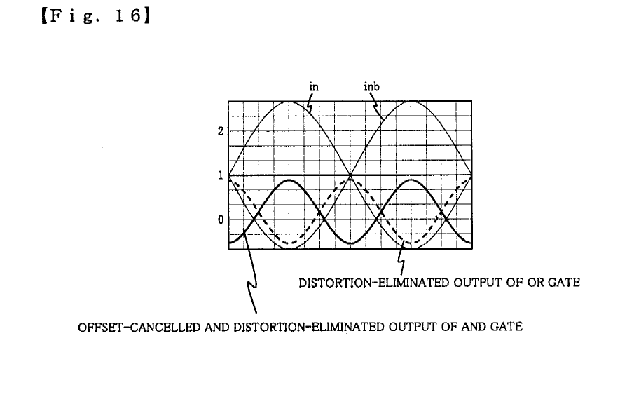

FIG. 16 is a diagram showing input/output waveforms in the circuits in absolute value converter 121, offset canceler 123 and distortion eliminator 124 shown in FIG. 15.

As shown in FIG. 16, it can be seen that output distortion of the AND gate and the OR gate is eliminated and the waveforms have been shaped, differently from the input/output waveforms shown in FIG. 13 serving no distortion eliminating function.

As described in the above, absolute value converter 121 comprising the AND gate and the OR gate obtains differential binary data from ternary data, so that a reference voltage does not need to be set to determine each voltage level. Additionally, digital conversion such as by an A/D converter is not needed, facilitating identification of received data. Moreover, the connection of distortion eliminator 124 reduces malfunctioning due to data distortion in high-speed transmission.

1. A data transmission system including a transmitting apparatus for transmitting data, and a receiving apparatus for receiving, via a transmission path, the data transmitted from said transmitting apparatus as duobinary data being ternary data, the data transmission system being characterized in that:
said receiving apparatus includes absolute value converting means for converting said duobinary data into binary data.

2. The data transmission system according to claim 1, being characterized in that said transmitting apparatus includes a precoder for converting inputted data into precoded data.

3. The data transmission system according to claim 1, being characterized in that said receiving apparatus includes offset cancel means for cancelling a common voltage offset of said binary data.

4. The data transmission system according to claim 3, being characterized in that said offset cancel means is connected to a rear stage of said absolute value converting means.

5. The data transmission system according to claim 3, being characterized in that said offset cancel means controls an output voltage of said absolute value converting means.

6. The data transmission system according to claim 1, being characterized in that said absolute converting means is a differential circuit comprising an AND gate and an OR gate.

7. The data transmission system according to claim 1, being characterized in that:
said receiving apparatus includes distortion eliminating means for eliminating distortion of said binary data; and
said distortion eliminating means is connected to a rear stage of said absolute value converting means.

8. The data transmission system according to claim 7, being characterized in that said distortion eliminating means is a low-pass filter.

9. The data transmission system according to claim 1, being characterized in that:
said receiving apparatus includes differential amplifying means for amplifying said binary data; and
said differential amplifying means is connected to a rear stage of said absolute value converting means.

10. A receiving apparatus for receiving, via a transmission path, data transmitted from a transmitting apparatus for transmitting data as duobinary data being ternary data, the receiving apparatus being connected to said transmitting apparatus via said transmission path, the receiving apparatus being characterized by:
including absolute value converting means for converting said duobinary data into binary data.

11. The receiving apparatus according to claim 10, being characterized by including offset cancel means for cancelling a common voltage offset of said binary data.

12. The receiving apparatus according to claim 11, being characterized in that said offset cancel means is connected to a rear stage of said absolute value converting means.

13. The receiving apparatus according to claim 11, being characterized in that said offset cancel means controls an output voltage of said absolute value converting means.

14. The receiving apparatus according to claim 10, being characterized in that said absolute converting means is a differential circuit comprising an AND gate and an OR gate.

15. The receiving apparatus according to claim 10, being characterized in that:
said receiving apparatus includes distortion eliminating means for eliminating distortion of said binary data; and
said distortion eliminating means is connected to a rear stage of said absolute value converting means.

16. The receiving apparatus according to claim 15, being characterized in that said distortion eliminating means is a low-pass filter.

17. The receiving apparatus according to claim 10, being characterized in that:
said receiving apparatus includes differential amplifying means for amplifying said binary data; and
said differential amplifying means is connected to a rear stage of said absolute value converting means.

18. A data transmission method in a data transmission system including a transmitting apparatus for transmitting data, and a receiving apparatus for receiving, via a transmission path, the data transmitted from said transmitting apparatus as duobinary data being ternary data, the data transmission method being characterized in that:
said receiving apparatus performs processing to convert said duobinary data into binary data.

19. The data transmission method according to claim 18, being characterized in that said transmitting apparatus performs processing to convert inputted data into precoded data.

20. The data transmission method according to claim 18, being characterized in that said receiving apparatus performs processing to cancel a common voltage offset of said binary data.

21. The data transmission method according to claim 18, being characterized in that said receiving apparatus performs processing to eliminate distortion of said binary data.

22. The data transmission method according to claim 18, being characterized in that said receiving apparatus performs processing to amplify said binary data.
